(19) United States
(12) Patent Application Publication
(10) Pub. No.: US 2010/0002946 A1
(43) Pub. Date: Jan. 7, 2010

(54) METHOD AND APPARATUS FOR COMPRESSING FOR DATA RELATING TO AN IMAGE OR VIDEO FRAME

(75) Inventors: Salih Dikbas, Allen, TX (US); Fan Zhai, Richardson, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/496,886

(22) Filed: Jul. 2, 2009

Related U.S. Application Data
(60) Provisional application No. 61/077,503, filed on Jul. 2, 2008.
(60) Provisional application No. 61/077,505, filed on Jul. 2, 2008.

(51) Int. Cl. G06K 9/00

(52) U.S. Cl. 382/251

(57) ABSTRACT

A method and an apparatus for compressing image data. The method includes dividing a line of an image into equal length fragments to form a coding unit, transforming and performing entropy coding to the coding unit, and compressing the image data based on the transformed entropy coded coding unit.

### CROSS-REFERENCE TO RELATED APPLICATIONS

This application claims benefit of U.S. provisional patent application Ser. Nos. 61/077,503 and 61/077,505, filed Jul. 2, 2008, which is herein incorporated by reference.

### BACKGROUND OF THE INVENTION

1. Field of the Invention

Embodiments of the present invention generally relate to a method and apparatus for compressing of data.

2. Description of the Related Art

In video coding and video processing, increased external (off-chip) memory requirements present a major system bottleneck. Use of external memory in video compression standards have increased tremendously with the widespread adoption of the recently developed standard, H.264/AVC. In MPEG-2, decoder has to store reference (I and P) and B frames. H.264/AVC enhances the coding efficiency beyond MPEG-2 at the cost of increased computational complexity and additional memory use and access; for example, H.264 uses multiple reference frames for motion estimation/compensation. Increased use of external memory requirements in video processing may be caused by several factors: use of memory as a communication medium for different processing modules, use of high picture resolution, use of high-quality video algorithms, etc. For example, high-quality de-interlacing and picture-rate up-conversion algorithms may require 5 fields, and 3 frames, respectively. Increased external memory usage entails not only increased external storage area but also increased memory bandwidth.

Therefore, for a video coding or processing system targeting to achieve the maximum available performance it is imperative to use all the required external memory. However, hardware constraints and cost make it challenging to use larger external memory in today's technology. Hence, to reduce memory storage or memory bandwidth some kind of frame compression/decompression method is needed.

Existing video compression standards are not directly applicable to frame recompression as their objectives are different. Frame recompression method should be very simple, and if possible offer a constant compression ratio, e.g. 2:1 compression ratio, whereas video coding standards are very complex and offer much higher compression ratios. In addition, frame recompression method should only process one frame at a time; hence, it can not exploit the inter-frame correlation.

Frame recompression could be lossy or lossless. In the lossless case there is no loss in the encoding-decoding process, i.e. the process is distortion-free; whereas in the lossy case distortion is introduced through quantization process. In order to guarantee a desired compression ratio lossy compression has to be utilized, and rate-distortion optimization has to be employed.

FIG. 1. depicts an embodiment of an image compression system. FIG. 1 comprises two main components: an encoder and a decoder. The encoder performs compression and is generally composed of three sub-blocks: 1) transformation, 2) quantization, and 3) entropy encoding. The output of the encoder is the encoded bit-stream, which is a compressed representation of the input data. This bit-stream is either stored or transmitted depending on the application. The decoder performs the decompression by doing the inverse of the steps in encoder in reverse order as shown in FIG. 1, namely 1) entropy decoding, 2) de-quantization, and 3) inverse transformation. The function of each encoder sub-block can be briefly explained as:
Transformation: to de-correlate the data by exploiting the spatial/temporal redundancy,
Quantization: to decrease the encoded bit-stream length at the cost of distortion,
Entropy encoding: to minimize the average code-word length.

FIG. 1 shows a general image compression system, which may be performed by a digital signal processor (DSP). If it is used as shown then it refers to lossy compression. If the quantization and de-quantization is omitted then it refers to lossless compression.

Thus, there is a need for a method and/or apparatus for compressing of images/video frames to reduce memory storage and/or memory bandwidth requirements.

### SUMMARY OF THE INVENTION

Embodiments of the current invention generally relate to a method and an apparatus for compressing image data. The method includes dividing a line of an image into equal length fragments to form a coding unit, transforming and performing entropy coding to the coding unit, and compressing the image data based on the transformed entropy coded coding unit.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. Herein, a computer readable medium is any medium that a computer can access, write, read, execute, store, archive date to and from.

FIG. 1. depicts an embodiment of an image compression system;

FIG. 2. depicts an embodiment of an illustration of one step forward lifting;

FIG. 3 depicts an embodiment of a block diagram for a lossy data compression system; and

FIG. 4 depicts another embodiment of a block diagram for a lossless data compression system.

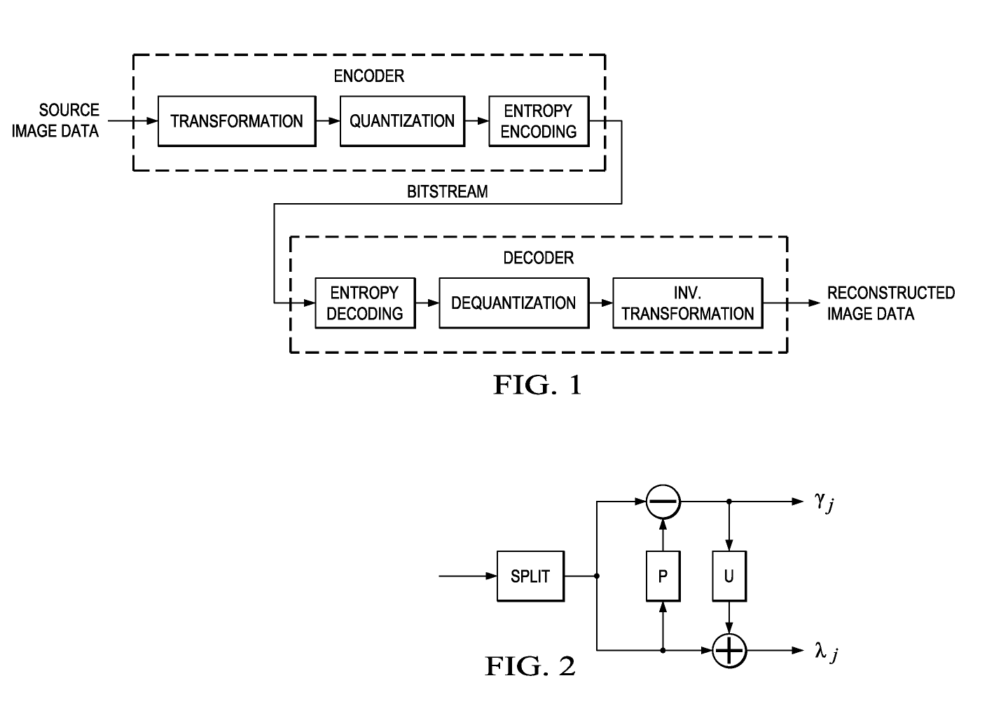

### DETAILED DESCRIPTION

Before giving the details of the proposed compression system, we would like to give a brief overview of the lossless compression and give some information about the methods used in encoder sub-blocks.

The transformation selection of the proposed compression method is chosen such that it enables lossless compression with a very hardware-friendly design, at the same time if needed it could easily be modified to perform lossy compression as well.

Lossless compression of images is desirable in order to save memory bandwidth and memory storage of imaging or video coding systems. In addition, for some applications it is crucial to use lossless compression due to the intolerance of application to distortion such as compression of medical and satellite images/videos. There are several widely used low-complexity lossless image compression techniques such as JPEG-LS and CALIC [JPEG-LS, Weinberger96, Memon97]. All of these algorithms use some sort of technique to reduce the spatial and coding redundancy.

Utilization of the spatial redundancy requires the use of additional line-storage memory ranging from one line-buffer to one frame-buffer. However, it is desirable to have lossless compression methods that require less than one line-buffer additional line-storage memory. If the required line-storage size can be made adjustable, then it can directly be used as a tradeoff tool between complexity and performance. Utilization of the coding redundancy is achieved by use of different entropy encoding methods, i.e. Huffman coding, arithmetic coding, run-length coding, Golomb coding, etc. These coding techniques offer different levels of performance at differing complexity levels. To have a low-complexity system it is desired that the implementation is very simple and it does not require involved arithmetic operations and big lookup tables.

In image processing and compression, Discrete Wavelet Transform (DWT) is widely used, and over the last two decades it proved itself to be a very efficient and powerful transformation method. There are several methods that are based on the use of wavelet transform [Shapiro93, Said96-1, Taubman00]. However, since the coefficients of DWT are floating-point numbers, the computational complexity increases and more importantly makes them unappealing for lossless coding applications.

On the other hand, the lifting scheme (LS) originally presented by Sweldens [Sweldens96] enables a low-complexity and more efficient implementation of DWT. Calderbank et. al. [Calderbank98] present such an algorithm based on LS, and it is called Integer Wavelet Transform (IWT). IWT has several advantages over DWT: 1) enables direct fixed-point implementation, 2) enables lossless coding, and 3) enables low-complexity implementation. Since IWT approximate their parent linear transforms, the efficiency of IWT may not be as good as the efficiency of DWT for lossy compression.

FIG. 2. depicts an embodiment of an illustration of one step forward lifting. In FIG. 2, P denotes prediction and U denotes the update stages. Inverse transform is obtained by reversing the steps of the forward transform and flipping the signs. In [Said96-2] several IWT are compared according to their lossy and lossless compression performance and computational complexity. Although, there is no one best IWT transform for all classes of images, S and 5/3 transform are very attractive due to their lower computational complexities and comparable performances. The complexity of S transform is lower than 5/3 transform, and performs slightly worse than 5/3 transform.

Forward and inverse 5/3 transformation equations for one lifting step are as below:

$$Forward \text{:} \{ \begin{matrix}y [ 2 n + 1 ] = x [ 2 n + 1 ] - ⌊ \frac{x [ 2 n ] + x [ 2 n + 2 ]}{2} ⌋ \\ y [ 2 n ] = x [ 2 n ] + ⌊ \frac{y [ 2 n - 1 ] + y [ 2 n + 1 ]}{4} + \frac{1}{2} ⌋\end{matrix} \\ Inverse \text{:} \{ \begin{matrix}x [ 2 n ] = y [ 2 n ] - ⌊ \frac{y [ 2 n - 1 ] + y [ 2 n + 1 ]}{4} + \frac{1}{2} ⌋ \\ x [ 2 n + 1 ] = y [ 2 n + 1 ] + ⌊ \frac{x [ 2 n ] + x [ 2 n + 2 ]}{2} ⌋\end{matrix}$$

where x, y[2n], and y[2n+1] are input, low-pass subband, and high-pass subband signal, respectively. Similarly, forward and inverse S transformation equations for one lifting step are as below:

$$Forward \text{:} \{ \begin{matrix}y [ 2 n + 1 ] = x [ 2 n + 1 ] - x [ 2 n ] \\ y [ 2 n ] = x [ 2 n ] + ⌊ \frac{y [ 2 n + 1 ]}{2} ⌋\end{matrix} \\ Inverse \text{:} \{ \begin{matrix}x [ 2 n ] = y [ 2 n ] - ⌊ \frac{y [ 2 n + 1 ]}{2} ⌋ \\ x [ 2 n + 1 ] = y [ 2 n + 1 ] + x [ 2 n ]\end{matrix}$$

Usually, more than one number of lifting steps is employed. To achieve that, illustration in FIG. 2 is cascaded for approximation terms for desired number of times. Inverse lifting step is also obtained similarly for more than one number of lifting steps. Note that the number of lifting steps is the same as the number of scales in DWT.

The choice of the quantization function used to obtain the integer values affects the performance of the overall method, especially at higher bit rates, which is the case in near-lossless and lossless compression. Simulation results show that the midtread quantizer performs better than the deadzone quantizer. Hence, we employ midtread quantization to minimize the degradation.

Different entropy encoding methods are suited best for different image data statistics. Exponential-Golomb (EG) codes are very attractive since they do not require any table lookup, and extensive calculation. Exponential-Golomb (EG) codes are among the VLC methods; they were originally proposed by Teuhola [Teuhola78] in the context of run-length coding that are parameterized by an integer k and expressed as EG(k), for k=0, 1, 2, . . . .

An EG(k) code for a positive symbol x is obtained by concatenation of a prefix code and a suffix code. The prefix code is obtained by unary coding of the value

$$M = ⌊ {log}_{2} ( \frac{x}{{2}^{k}} + 1 ) ⌋ ,$$

i.e. M number of zeros (or ones) followed by a one (or zero). The suffix code is M+k bit binary representation of r=x−2^{k}(2^{M}−1), where 0≦r<2^{k+M}. Hence, the resulting codeword will be in the following format:

$${\overbrace{00 … 001}}^{prefix code} {\overbrace{{x}_{M + k - 1} {x}_{M + k - 2} … {x}_{1} {x}_{0}}}^{suffix code}$$

Table 1 shows EG codes for k=1, 2, 3, and 4 for values of x between 0-15.

Different k values suit to different image data statistics. For example, EG(0) may suit better to data statistics with Laplacian distributed values ranging between 1-10. As can be seen from the Table 1 that as the range of values become larger, the EG codes with larger k values might become more suitable.

TABLE 1
Exponential-Golomb codes for k = 0, 1, 2, and 3

| | Codeword | | Codeword | | Codeword | | Codeword | |
|---|---|---|---|---|---|---|---|---|
| Symbol n | k = 0 | Bits | k = 1 | Bits | k = 2 | Bits | k = 3 | Bits |
| 0 | 1 | 1 | 10 | 2 | 100 | 3 | 1000 | 4 |
| 1 | 0 10 | 3 | 11 | 2 | 101 | 3 | 1001 | 4 |
| 2 | 0 11 | 3 | 0 100 | 4 | 110 | 3 | 1010 | 4 |
| 3 | 00 100 | 5 | 0 101 | 4 | 111 | 3 | 1011 | 4 |
| 4 | 00 101 | 5 | 0 110 | 4 | 0 1000 | 5 | 1100 | 4 |
| 5 | 00 110 | 5 | 0 111 | 4 | 0 1001 | 5 | 1101 | 4 |
| 6 | 00 111 | 5 | 00 1000 | 6 | 0 1010 | 5 | 1110 | 4 |
| 7 | 000 1000 | 7 | 00 1001 | 6 | 0 1011 | 5 | 1111 | 4 |
| 8 | 000 1001 | 7 | 00 1010 | 6 | 0 1100 | 5 | 0 10000 | 6 |
| 9 | 000 1010 | 7 | 00 1011 | 6 | 0 1101 | 5 | 0 10001 | 6 |
| 10 | 000 1011 | 7 | 00 1100 | 6 | 0 1110 | 5 | 0 10010 | 6 |
| 11 | 000 1100 | 7 | 00 1101 | 6 | 0 1111 | 5 | 0 10011 | 6 |
| 12 | 000 1101 | 7 | 00 1110 | 6 | 00 10000 | 7 | 0 10100 | 6 |
| 13 | 000 1110 | 7 | 00 1111 | 6 | 00 10001 | 7 | 0 10101 | 6 |
| 14 | 000 1111 | 7 | 000 10000 | 8 | 00 10010 | 7 | 0 10110 | 6 |
| 15 | 0000 10000 | 9 | 000 10001 | 8 | 00 10011 | 7 | 0 10111 | 6 |

Rate-Distortion (RD) optimization problem can be stated in different ways: budget-constrained, distortion-constrained, delay constrained, etc. In our application we are interested in budget-constrained RD optimization; we want to guarantee that the rate does not exceed a predetermined threshold, R_{T}.

Mathematically, budget-constrained RD problem can be stated as

$$minimize D = f ( {d}_{1}^{{q}_{1}} , {d}_{2}^{{q}_{2}} , {d}_{3}^{{q}_{3}} , … , {d}_{N}^{{q}_{N}} )$$

$$such that R = {\sum }_{i = 1}^{N} {r}_{i}^{q} \leq {R}_{T}$$

where N is the number of coding units and each coding unit has M different available operating points, i.e. M different quantizers. For each coding unit i, rᵢ^{q}^{ᵢ} denotes its rate and dᵢ^{q}^{ᵢ} denotes its distortion when using quantizer qᵢε{1, 2, . . . , M}. qᵢ=1 means no quantization, and increasing value implies increasing amount of quantization, i.e. qᵢ=M means the largest amount of quantization.

In the above formulation, distortion metric f(d₁^{q}^{₁}, d₂^{q}^{₂}, d₃^{q}^{₃}, . . . , d_{N}^{q}^{_{N}}) can be any function of distortion. For our application we are interested in a minimum average distortion, hence

$$f ( {d}_{1}^{{q}_{1}} , {d}_{2}^{{q}_{2}} , {d}_{3}^{{q}_{3}} , … , {d}_{N}^{{q}_{N}} ) = {\sum }_{i = 1}^{N} {d}_{i}^{{q}_{i}} .$$

This optimization problem can be effectively solved using dynamic programming methods such as Viterbi algorithm or Dijkstra's shortest-path algorithm. Although, the optimal solution is obtained with these methods, their complexity prevents us from using them. One other alternative is to use Lagrangian optimization, i.e. minimize J=D+λR. In order to achieve the optimal solution we need to have the optimal λ value so that the resulting rate is close or equal to the set budget limit. However, finding the right λ requires that rᵢ^{q}^{ᵢ} and dᵢ^{q}^{ᵢ} be available for all coding units, and that increases the complexity. Hence, we cannot use these methods directly.

By sacrificing from the quality, the problem may be modified to obtain a sub optimal solution. Additional N−1 constraints are added, as shown below:

$$minimize D = f ( {d}_{1}^{{q}_{1}} , {d}_{2}^{{q}_{2}} , {d}_{3}^{{q}_{3}} , … , {d}_{N}^{{q}_{N}} )$$

$$such that R = {\sum }_{i = 1}^{N} {r}_{i}^{{q}_{i}} \leq {R}_{T}$$

$${\sum }_{i = 1}^{k} {r}_{i}^{{q}_{i}} \leq {R}_{T} \frac{k}{N} k = 1 , … , N - 1$$

Hence, the sub-optimal solution is obtained by deciding each q₁ at a time as follows. For the first coding unit choose the lowest q₁ value such that,

$${r}_{1}^{{q}_{1}} \leq {R}_{T} \frac{1}{N}$$

is satisfied. Then, for the following coding units choose the lowest qₖ value such that, or equivalently,

$${\sum }_{i = 1}^{k} {r}_{i}^{{q}_{i}} = {\sum }_{i = 1}^{k - 1} {r}_{i}^{{q}_{i}} + {r}_{k}^{{q}_{k}} \leq {R}_{T} \frac{k}{N} k = 2 , … , N$$

$${r}_{k}^{{q}_{k}} \leq {R}_{T} \frac{k}{N} - {\sum }_{i = 1}^{k - 1} {r}_{i}^{{q}_{i}} k = 2 , … , N$$

$${r}_{k}^{{q}_{k}} \leq {R}_{T} \frac{1}{N} + ( {R}_{T} \frac{k - 1}{N} - {\sum }_{i = 1}^{k - 1} {r}_{i}^{{q}_{i}} ) k = 2 , … , N$$

is satisfied. The term in parentheses is the accumulated unused bit-rate from the previous coding units. The accumulated unused bit-rate could be distributed more prudently among the next L coding units by modifying the formulation as below:

Then, the resulting q*=[q*₁, q*₂, . . . , q*_{N}] is the sub-optimal set of quantizers selection.

$$minimize D = f ( {d}_{1}^{{q}_{1}} , {d}_{2}^{{q}_{2}} , {d}_{3}^{{q}_{3}} , … , {d}_{N}^{{q}_{N}} )$$

$$such that {\sum }_{i = 1}^{N} {r}_{i}^{{q}_{i}} \leq {R}_{T} \frac{1}{N}$$

$${r}_{k}^{{q}_{k}} \leq {R}_{T} \frac{1}{N} + \frac{1}{L} ( {R}_{T} \frac{k - 1}{N} - {\sum }_{i = 1}^{k - 1} {r}_{i}^{{q}_{i}} ) k = 1 , … , N - 1$$

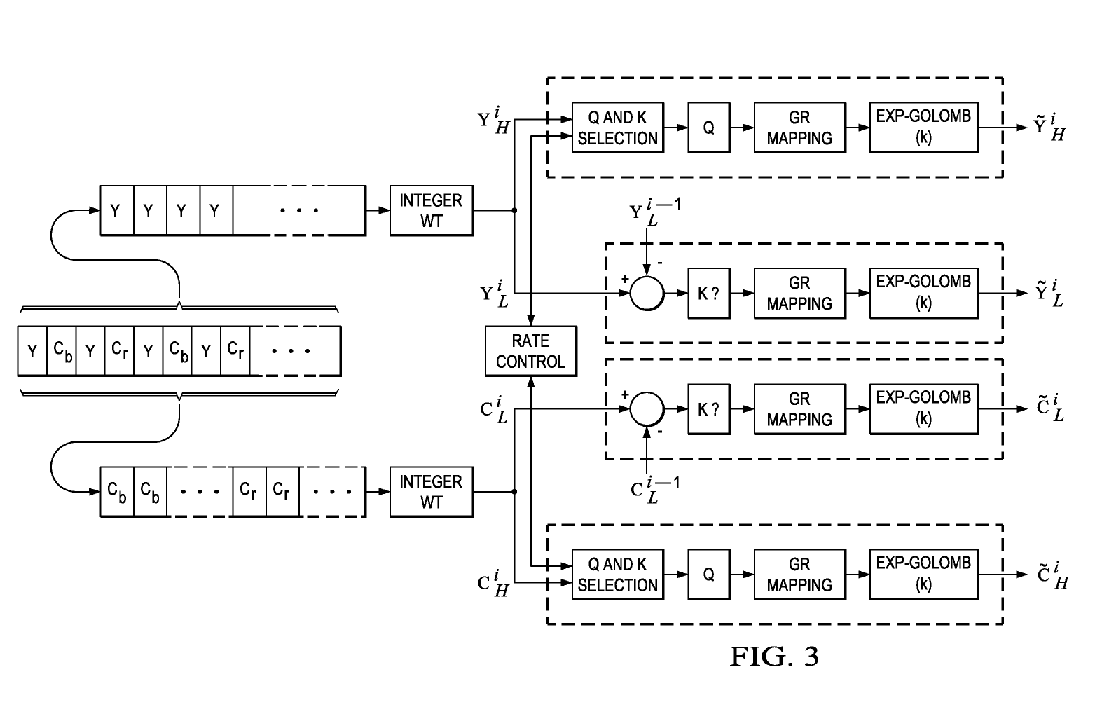

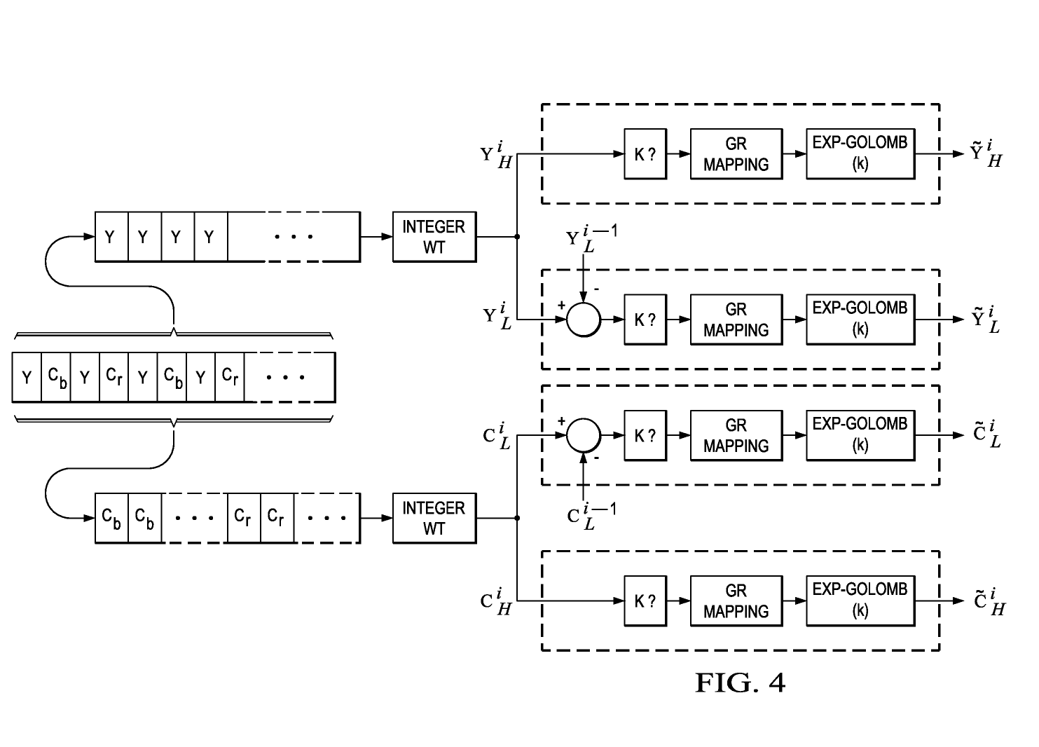

Incoming interleaved pixel data, luminance (Y) and chrominance (C), is first de-interleaved and corresponding Y and C are formed. Incoming data can be in any chroma sampling format (4:4:4, 4:2:2, 4:2:0, etc.); for example, FIG. 3 depicts an embodiment of a block diagram for a data compression system. In FIG. 3 chroma sampling format of 4:2:2 is illustrated. If the incoming data is in RGB domain, then reversible component transformation (RCT) may be used for RGB to YCbCr conversion. The compression system works on fragments of data. A frame is composed of lines, and each line is divided into equal-length fragments. Size of the fragment should be chosen such that it divides the line-length evenly, and at the same time it is a multiple of 2^{scales}. These formed Y and C data is processed a fragment at a time. First, IWT of Y and C is taken.

Second, transformed domain data is split into low and high frequency data, or equivalently called approximate and detail data. Then, for high-frequency components suitable Q and k values that give the minimum coded-length is chosen; after Golomb-Rice (GR) mapping, they are coded using EG(k). GR mapping maps negative integers to positive odd integers and non-negative integers to positive even integers. Low-frequency components go through the similar steps except the following two steps at the beginning: 1) a prediction is performed by taking the difference of the low-frequency data of the current fragment and the co-located fragment of the previous line, and 2) no quantization is applied to the low-frequency data due to its importance.

Compressed data for each image is obtained by concatenating the compressed data of each fragment. For each fragment, compressed bit-stream is composed of header and encoded coefficient data. Header is 7-bits wide and stores the 3-bits quantization index and 4-bits k selections, where 1-bit is used for each k selection of low and high frequency luma and chroma components. Compressed bitstream may be either a single bit-stream containing both luma and chroma information or two separate bitstreams for luma and chroma to enable asynchronous access.

To have a robust encoder for different image statistics, we designed the encoder so that it selects the best EG code out of two different EG codes. Based on our extensive simulations including different image types we chose k=0 and 3. However, we made them to be programmable so that different applications may use different set of k values to better utilize the EG code selection for different image types and applications.

In one embodiment, method and/or apparatus compress the image/video frame at a guaranteed desired compression ratio. Each line of an image is divided into equal-length fragments, and they are the basic coding units of the proposed algorithm. Each coding unit data is transformed, quantized, and entropy coded to compress the given data. A rate-control algorithm is used to ensure that each image is compressed at the desired compression ratio.

While the foregoing is directed to embodiments of the present invention, other and further embodiments of the invention may be devised without departing from the basic scope thereof, and the scope thereof is determined by the claims that follow.

What is claimed is:

1. A method of a digital signal processor for compressing image data, comprising:
dividing a line of an image into equal length fragments to form a coding unit;
transforming and performing entropy coding to the coding unit; and
compressing the image data based on the transformed entropy coded coding unit.

2. The method of claim 1 further comprising performing quantization on the coding unit.

3. The method of claim 1 further comprising utilizing a rate control algorithm to ensure a predetermined compression rate.

4. An apparatus for compressing image data, comprising:
means dividing a line of an image into equal length fragments to form a coding unit;
means for transforming and performing entropy coding to the coding unit; and
means for compressing the image data based on the transformed entropy coded coding unit.

5. The apparatus of claim 4 further comprising means for performing quantization on the coding unit.

6. The apparatus of claim 4 further comprising means for utilizing a rate control algorithm to ensure a predetermined compression rate.

7. A computer readable medium comprising software that, when executed by a processor, causes the processor to perform a method for compressing image data, the method comprising:
dividing a line of an image into equal length fragments to form a coding unit;
transforming and performing entropy coding to the coding unit; and
compressing the image data based on the transformed entropy coded coding unit.

8. The method of claim 7 further comprising performing quantization on the coding unit.

9. The method of claim 7 further comprising utilizing a rate control algorithm to ensure a predetermined compression rate.
